(19) United States
(12) Patent Application Publication
(10) Pub. No.: US 2024/0239928 A1
(43) Pub. Date: Jul. 18, 2024

(54) CATALYST SUPPORTS AND USES THEREOF

(71) Applicants: Oxford University Innovation Limited, Oxford (GB); SCG CHEMICALS PUBLIC COMPANY LIMITED, Bangkok (TH)

(72) Inventors: Dermot O'HARE, Oxford (GB); Jean-Charles BUFFET, Oxford (GB); Zoe R. TURNER, Oxford (GB); Philip KENYON, Oxford (GB)

(21) Appl. No.: 18/559,067

(22) PCT Filed: May 13, 2022
(86) PCT No.: PCT/GB2022/051218

§ 371 Date: Nov. 6, 2023

(30) Foreign Application Priority Data
May 14, 2021 (GB) 2106951.3

(51) Int. Cl. C08F 110/02; C01F 7/785

(52) U.S. Cl. CPC C08F 110/02; C01F 7/785; C01P 2002/72; C01P 2002/77; C01P 2002/88

(57) ABSTRACT

Catalyst supports prepared from Ni²⁺-containing layered double hydroxides are disclosed. together with processes by which they are made and catalyst compositions comprising them. When used in the polymerisation of an olefin. the catalyst supports give control over the molecular weight distribution of the resulting polyolefin.

### INTRODUCTION

The present invention relates to catalyst supports for supporting olefin polymerisation catalysts, as well as to processes for making the catalyst supports. More particularly, the present invention relates to catalyst supports prepared from Ni²⁺-containing layered double hydroxides. The present invention also relates to catalyst compositions comprising an olefin polymerisation catalyst supported on the catalyst support, as well as to the use of the catalyst compositions in olefin polymerisation reactions.

### BACKGROUND OF THE INVENTION

The material properties of a polymer are intrinsically linked to the molecular weight distribution (MWD) of the individual chains. High molecular weight polyethylenes have high tensile strength and abrasion resistance,¹ while low molecular weight polyethylenes are easily processed due to a low melt viscosity and rapid crystallisation. Blending of these polymers with distinct MWDs allows for tailoring of the material properties to allow for improved mechanical properties and/or enhanced processability.²

While polyethylene blends can be produced simply by melt-blending of two or more polymers, this can be problematic with (ultra)high molecular weight polyethylenes due to high viscosities limiting mixing. A more elegant solution is to directly produce a polymer with two distinct MWDs directly in the reactor, this ensures good mixing and reduces the energy costs associated with melt-blending. Classical polyethylene catalysts such as Ziegler-Natta and Phillips systems produce polymers with (very) broad MWDs due to the multi-site nature of these catalysts. By comparison the single site nature of metallocenes and other well-defined homogenous catalysts produce narrow monomodal MWDs.

A tailored MWD can be produced in a number of ways. A single catalyst can be used to produce several distinct MWDs sequentially by changing the reactions conditions,³ using reactor cascades or introducing a chain transfer-agent.

Alternatively, two or more catalysts can be used together, either in solution⁴ on two separate supports⁵ or combined on a single support with each catalyst producing a distinct MWD under one set of conditions. Recently, Mulhaupt and coworkers, demonstrated a third example whereby varying the amount of methylaluminoxane used to immobilise a chromium catalyst, distinct MWDs could be obtained.⁶

In spite of the advances in this field, there remains a need for exerting control over the MWD of polymer chains formed during the polymerisation of olefins, in particular ethylene. There is a particular need for a means of straightforwardly preparing polyolefins, especially polyethylene, having a bimodal MWD.

The present invention was devised with the foregoing in mind.

### SUMMARY OF THE INVENTION

According to a first aspect of the present invention there is provided a process for preparing a catalyst support, the process comprising the steps of:
a) providing a layered double hydroxide, the layered double hydroxide comprising Ni²⁺;
b) thermally treating the layered double hydroxide to a temperature of 100-600° C.; and
c) contacting the thermally treated layered double hydroxide with an organoaluminium compound.

According to a second aspect of the present invention there is provided a process for preparing a catalyst composition, the process comprising the steps of:
a) providing a layered double hydroxide, the layered double hydroxide comprising Ni²⁺;
b) thermally treating the layered double hydroxide to a temperature of 100-600° C.;
c) contacting the thermally treated layered double hydroxide with an organoaluminium compound; and
d) supporting an olefin polymerisation catalyst on the thermally treated layered double hydroxide;
   wherein step d) is performed before, concurrent with, or after step c).

It will be appreciated that any one or more of steps a), b) and c) of the second aspect may respectively have any the definitions outlined herein in relation to steps a), b) and c) of the first aspect.

According to a third aspect of the present invention there is provided a catalyst support obtainable, obtained or directly obtained by the process of the first aspect.

According to a fourth aspect of the present invention there is provided a catalyst composition obtainable, obtained or directly obtained by the process of the second aspect.

According to a fifth aspect of the present invention there is provided an olefin polymerisation process comprising the step of polymerising an olefin (e.g. ethylene) in the presence of the catalyst composition of the fourth aspect.

### DETAILED DESCRIPTION OF THE INVENTION

### Definitions

The term “(m-nC)” or “(m-nC) group” used alone or as a prefix, refers to any group having m to n carbon atoms.

The term “alkyl” as used herein refers to straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl, hexyl and the like. Most suitably, an alkyl may have 1, 2, 3 or 4 carbon atoms.

The term “alkenyl” as used herein refers to straight or branched chain alkenyl moieties, typically having 1, 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein refers to straight or branched chain alkynyl moieties, typically having 1, 2, 3, 4, 5 or 6 carbon atoms. The term includes reference to alkynyl moieties containing 1, 2 or 3 carbon-carbon triple bonds (C═C). This term includes reference to groups such as ethynyl, propynyl, butynyl, pentynyl and hexynyl.

The term “alkoxy” as used herein refers to —O-alkyl, wherein alkyl is as defined herein. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” or “aromatic” as used herein means an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “heteroaryl” or “heteroaromatic” means an aromatic mono-, bi-, or polycyclic ring incorporating one or more (for example 1-4, particularly 1, 2 or 3) heteroatoms selected from nitrogen, oxygen or sulfur. Examples of heteroaryl groups are monocyclic and bicyclic groups containing from five to twelve ring members, and more usually from five to ten ring members. The heteroaryl group can be, for example, a 5- or 6-membered monocyclic ring or a 9- or 10-membered bicyclic ring, for example a bicyclic structure formed from fused five and six membered rings or two fused six membered rings. Each ring may contain up to about four heteroatoms typically selected from nitrogen, sulfur and oxygen. Typically, the heteroaryl ring will contain up to 3 heteroatoms, more usually up to 2, for example a single heteroatom.

The term “aryloxy” as used herein refers to —O-aryl, wherein aryl is as defined herein. Suitably, aryl is optionally substituted phenyl.

The term “halogen” or “halo” as used herein refers to F, Cl, Br or I. In a particular, halogen may be F or Cl, of which CI is more common.

The term “substituted” as used herein in reference to a moiety means that one or more, especially up to 5, of the hydrogen atoms in said moiety are replaced independently of each other by the corresponding number of the described substituents. Preferably, “substituted” as used herein in reference to a moiety means that 1, 2 or 3, of the hydrogen atoms in said moiety are replaced independently of each other by the corresponding number of the described substituents. Even more preferred, “substituted” as used herein in reference to a moiety means that 1 or 2, of the hydrogen atoms in said moiety are replaced independently of each other by the corresponding number of the described substituents. The term “optionally substituted” as used herein means substituted or unsubstituted.

It will, of course, be understood that substituents may only be at positions where they are chemically possible, the person skilled in the art being able to decide (either experimentally or theoretically) without inappropriate effort whether a particular substitution is possible.

Throughout the entirety of the description and claims of this specification, where subject matter is described herein using the term “comprise” (or “comprises” or “comprising”), the same subject matter instead described using the term “consist of” (or “consists of” or “consisting of”) or “consist essentially of” (or “consists essentially of” or “consisting essentially of”) is also contemplated.

Throughout the description and claims of this specification, the singular encompasses the plural unless the context otherwise requires. In particular, where the indefinite article is used, the specification is to be understood as contemplating plurality as well as singularity, unless the context requires otherwise.

Features described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any of the specific embodiments recited herein. The invention extends to any novel one, or any novel combination, of the features disclosed in this specification (including any accompanying claims, abstract and drawings), or to any novel one, or any novel combination, of the steps of any method or process so disclosed.

Unless otherwise specified, where the quantity or concentration of a particular component of a given product is specified as a weight percentage (wt. % or % w/w), said weight percentage refers to the percentage of said component by weight relative to the total weight of the product as a whole. It will be understood by those skilled in the art that the sum of weight percentages of all components of a product will total 100 wt. %. However, where not all components are listed (e.g. where a product is said to “comprise” one or more particular components), the weight percentage balance may optionally be made up to 100 wt. % by unspecified ingredients.

### Catalyst Supports

According to a first aspect of the present invention there is provided a process for preparing a catalyst support, the process comprising the steps of:
a) providing a layered double hydroxide, the layered double hydroxide comprising Ni²⁺;
b) thermally treating the layered double hydroxide to a temperature of 100-600° C.; and
c) contacting the thermally treated layered double hydroxide with an organoaluminium compound.

Through rigorous investigations, the inventors have devised catalyst supports useful in the preparation of polyolefins having tuneable MWD properties. In particular, when used in conjunction an olefin polymerisation catalyst (e.g. an ansa-metallocene) the catalyst supports of the invention allow for the preparation of a polyolefin, especially a polyethylene, having a multimodal (e.g. bimodal) MWD. When compared with the aforementioned prior art techniques for controlling the MWD of polyolefins, the catalyst supports of the invention represent a sophisticated yet simple means of accessing multimodal polyolefins. Thus, the catalyst supports are suitable for supporting an olefin polymerisation catalyst, such as one of those described herein.

The catalyst supports of the invention are prepared from Ni²⁺-containing layered double hydroxides. The structure of layered double hydroxides will be readily familiar to one of ordinary skill in the art as comprising a stack of positively charged, brucite-like layers of octahedral metal hydroxides intercalated by exchangeable, charge-balancing anions, where water typically provides hydrogen bonding between the positively charged layers. The layers of metal hydroxides are typically formed from a mixture of divalent and trivalent metal cations, although variants in which the divalent cation is replaced by (or supplemented with) a monovalent cation and/or the trivalent cation is replaced by (or supplemented with) a tetravalent cation are known.

The layered double hydroxides used to prepare the catalyst supports of the invention comprise Ni²⁺ (i.e. divalent nickel cations) in the positively charged metal hydroxide layers. The inventors have surprisingly found that increasing the quantity of Ni²⁺ in the layered double hydroxide renders the resulting catalyst support capable of affording a multimodal polyolefin (especially a bimodal polyethylene) despite using only a single olefin polymerization catalyst. Therefore, the quantity of Ni²⁺ in the catalyst support can be used to tune the MWD of a polyolefin, such as polyethylene.

Ni²⁺ may account for at least 10 mol % of all monovalent and divalent metal cations present within the layered double hydroxide provided in step a). The quantity of Ni²⁺ in the layered double hydroxide can be readily determined by, for example, elemental analysis using inductively coupled plasma mass spectrometry (ICP-MS). Suitably, Ni²⁺ accounts for at least 30 mol % of all monovalent and divalent metal cations present within the layered double hydroxide provided in step a). More suitably, Ni²⁺ accounts for at least 50 mol % of all monovalent and divalent metal cations present within the layered double hydroxide provided in step a). Even more suitably, Ni²⁺ accounts for at least 70 mol % of all monovalent and divalent metal cations present within the layered double hydroxide provided in step a). Yet more suitably, Ni²⁺ accounts for at least 90 mol % of all monovalent and divalent metal cations present within the layered double hydroxide provided in step a). Yet even more suitably, Ni2+accounts for at least 95 mol % of all monovalent and divalent metal cations present within the layered double hydroxide provided in step a).

In particular embodiments, Ni²⁺ may account for substantially all (or all) monovalent and divalent metal cations present within the layered double hydroxide provided in step a). The mole ratio of Ni²⁺ to all trivalent and tetravalent metal cations present within the layered double hydroxide (e.g., Al³⁺) may be 1.9:1 to 3.1:1, or more suitably 2:1 to 3:1 (e.g., 2:1 or 3:1).

One or more of Mg²⁺, Zn²⁺, Fe²⁺, Ca²⁺, Cu²⁺ and Mn²⁺ may form the optional balance of all monovalent and divalent metal cations present within the layered double hydroxide provided in step a). The term optional balance will be understood to refer to all non-Ni²⁺ monovalent and divalent metal cations present within the layered double hydroxide, recognising that in particular embodiments, Ni²⁺ may account for substantially all (or all) monovalent and divalent metal cations present within the layered double hydroxide. Accordingly, the term optional balance encompasses two alternatives: i) where Ni²⁺ accounts for all monovalent and divalent metal cations present within the layered double hydroxide (i.e., no balance of monovalent and divalent metal cations exists), and ii) where Ni²⁺ does not account for all monovalent and divalent metal cations present within the layered double hydroxide (i.e., a balance of monovalent and divalent metal cations exists). Suitably, Mg²⁺ forms the optional balance of all monovalent and divalent metal cations present within the layered double hydroxide provided in step a).

As discussed hereinbefore, it will be understood that the layered double hydroxide provided in step a) comprises at least one trivalent or tetravalent metal cation. One or more of Al³⁺, Ga³⁺, Fe³⁺, Co³⁺, Mn³⁺ and V³⁺ may account for all trivalent and tetravalent metal cations present within the layered double hydroxide provided in step a). Suitably, Al³⁺ accounts for all trivalent and tetravalent metal cations present within the layered double hydroxide provided in step a).

In particular embodiments, Mg²⁺ forms the optional balance of all monovalent and divalent metal cations present within the layered double hydroxide provided in step a) and Al³⁺ accounts for all trivalent and tetravalent metal cations present within the layered double hydroxide provided in step a).

As discussed hereinbefore, it will be understood that the layered double hydroxide provided in step a) comprises at least one anion. One or more of a halide, an inorganic oxyanion and a surfactant may account for all anions present within the layered double hydroxide provided in step a). Exemplary halides include fluoride, chloride and bromide, of which chloride is preferred. Exemplary inorganic oxyanions include carbonate, bicarbonate, nitrate, nitrite, sulfate, borate and phosphate, of which carbonate is preferred. Exemplary surfactants include fatty acid salts, such as sodium dodecyl sulfate and sodium stearate. Suitably, one or more inorganic oxyanions account for all anions present within the layered double hydroxide provided in step a). More suitably, carbonate accounts all anions present within the layered double hydroxide provided in step a).

In particular embodiments, Mg²⁺ forms the optional balance of all monovalent and divalent metal cations present within the layered double hydroxide provided in step a), Al³⁺ accounts for all trivalent and tetravalent metal cations present within the layered double hydroxide provided in step a), and one or more inorganic oxyanions account for all anions present within the layered double hydroxide provided in step a). Suitably, the one or more inorganic oxyanions is carbonate.

The layered double hydroxide provided in step a) may be of formula (I):

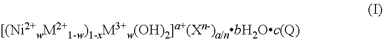

wherein
M²⁺ is at least one divalent metal cation;
M³⁺ is at least one trivalent metal cation;
0.1≤w≤1;
0<x<0.9;
0≤b≤10;
0≤c≤10;
X is an anion
n is the charge on anion X
a=x; and
Q is an organic solvent capable of hydrogen bonding to water.

M²⁺ may be one or more of Mg²⁺, Zn²⁺, Fe²⁺, Ca²⁺ , Cu²⁺ and Mn²⁺. Suitably, M²⁺ is one or more of Mg²⁺, Zn²⁺, Fe²⁺ and Ca²⁺. More suitably, M²⁺ is Mg²⁺.

M³⁺ may be one or more of Al³⁺, Ga³⁺, Fe³⁺, Co³⁺, Mn³⁺ and V³⁺. Suitably, M³⁺ is one or more of Al³⁺, Ga³⁺ and Fe³⁺. More suitably, M³⁺ is Al³⁺.

In particular embodiments, M²⁺ is Mg²⁺ and M³⁺ is Al³⁺.

X may be one or more selected from a halide, an inorganic oxyanion and a surfactant. Exemplary halides include fluoride, chloride and bromide, of which chloride is preferred. Exemplary inorganic oxyanions include carbonate, bicarbonate, nitrate, nitrite, sulfate, borate and phosphate, of which carbonate is preferred. Exemplary surfactants include fatty acid salts, such as sodium dodecyl sulfate and sodium stearate. Suitably, X is an inorganic oxyanion. More suitably, X is carbonate.

In particular embodiments, M²⁺ is Mg²⁺, M³⁺ is Al³⁺ and X is carbonate.

Suitably, 0.3≤w≤1. More suitably, 0.5≤w≤1. Even more suitably, 0.7≤w≤1. Yet more suitably, 0.9≤w$1. Yet even more suitably, 0.95≤w≤1. It will be understood that the symbol “≤” (i.e., less-than-or-equal-to) encompasses two alternatives, namely less than and equal to. Therefore, in any of the aforementioned ranges, w may be <1. In particular embodiments, w=1.

Alternatively, 0.25≤w≤0.75. In particular embodiments, w=0.33, 0.5 or 0.66.

Suitably, 0.1≤x≤0.5. More suitably, 0.2≤x≤0.4.

Q may be an organic solvent capable of donating hydrogen bonds to, or accepting hydrogen bonds from, water. Organic solvents containing hydrogen bond donating and accepting moieties will be readily familiar to one of ordinary skill in the art. Particular, non-limiting classes of organic solvents capable of hydrogen bonding to water are alcohols, ketones and aldehydes. Suitably, Q is one or more selected from acetone, ethanol, methanol and 1-hexanol. In particular embodiments, Q is ethanol.

Suitably, 0<c≤10. Layered double hydroxides in which c>0 have physical properties that make them particularly suitable for use in the preparation of catalyst supports. In particular, such layered double hydroxides may exhibit an increased surface area, increased pore volume and/or a reduced density relative to layered double hydroxides in which c=0. In particular embodiments, 0<c≤10 and Q is ethanol.

Layered double hydroxides in which 0<c≤10 can be readily prepared by one of skill in the art. For example, such layered double hydroxides can be produced by first precipitating a layered double hydroxide from an aqueous (i.e. water-containing) solvent, and then contacting (e.g. by washing or dispersing) the resulting, water-wet layered double hydroxide with one or more organic solvents, Q as defined herein. The term water-wet will be understood to mean that the precipitated layered double hydroxide is not allowed to become dry before it is contacted with the one or more organic solvents, Q. The precipitated layered double hydroxide may be washed with water before it is contacted with (e.g. washed with or dispersed in) the one or more organic solvents, Q.

The layered double hydroxide may be a layered double hydroxide of formula (Ia):

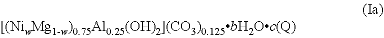

wherein w is 0.33, 0.66 or 1, and b, c and Q are as defined hereinbefore in relation to formula (I). Suitably, 0<c≤10 and Q is ethanol. In some embodiments, w is 0.33 or 0.66.

The layered double hydroxide may be a layered double hydroxide of formula (Ib):

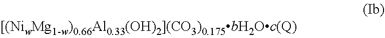

wherein w is 0.5 or 1, and b, c and Q are as defined hereinbefore in relation to formula (I). Suitably, 0<c≤10 and Q is ethanol. In some embodiments, w is 0.5.

The layered double hydroxide may be a layered double hydroxide of formula (Ic):

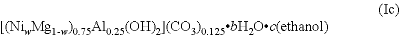

wherein w is 0.33, 0.66 or 1, and b and c are as defined hereinbefore in relation to formula (I). Suitably, 0<c≤10. In some embodiments, w is 0.33 or 0.66.

The layered double hydroxide may be a layered double hydroxide of formula (Id):

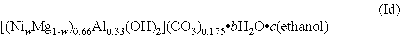

wherein w is 0.5 or 1, and b and c are as defined hereinbefore in relation to formula (I). Suitably, 0<c≤10. In some embodiments, w is 0.5.

In step b), the layered double hydroxide is thermally treated (suitably under vacuum) to a temperature of 100-600° C. to yield a thermally treated layered double hydroxide. Suitably, step b) comprises thermally treating the layered double hydroxide provided in step a) to a temperature of 125-500° C. More suitably, step b) comprises thermally treating the layered double hydroxide provided in step a) to a temperature of 150-450° C. Even more suitably, step b) comprises thermally treating the layered double hydroxide provided in step a) to a temperature of 300-425° C. The layered double hydroxide may be thermally treated to the stated temperature at a rate of 3-20 K/minute, more suitably 5-15 K/minute. Once at the stated temperature, the layered double hydroxide may be heated for 0.5-5 hours, more suitably, 2-4 hours.

In particular embodiments, step b) comprises thermally treating the layered double hydroxide provided in step a) to a temperature of 300-425° C. at a rate of 3-20 K/minute, and is then held at 300-425° C. for 2-4 hours. In such embodiments, step b) is suitably conducted under vacuum.

The organoaluminium compound used in step c) may be one or more of an alkyl aluminoxane and a trialkylaluminium compound. Exemplary alkyl aluminoxanes include, without limitation, those in which the alkyl group is methyl (i.e. methylaluminoxane, MAO), ethyl (i.e. ethylaluminoxane, EAO) and isobutyl (i.e. isobutylaluminoxane, IBAO), as well as those containing a mixture of two or more of the aforementioned alkyl groups. Exemplary trialkylaluminium compounds include, without limitation, trimethyl aluminium, triethyl aluminium and triisobutyl aluminium. Suitably, the organoaluminium compound is an alkyl aluminoxane, and is most suitably methylaluminoxane.

The amount of the organoaluminium compound used in step c) may be 10-70 wt % relative to the mass of the thermally treated layered double hydroxide. Suitably, step c) comprises contacting the thermally treated layered double hydroxide with 25-55 wt % of the organoaluminium compound relative to the mass of the thermally treated layered double hydroxide. More suitably, step c) comprises contacting the thermally treated layered double hydroxide with 35-45 wt % of the organoaluminium compound relative to the mass of the thermally treated layered double hydroxide.

In particular embodiments, the organoaluminium compound is an alkyl aluminoxane, suitably methylaluminoxane, and step c) comprises contacting the thermally treated layered double hydroxide with 35-45 wt % of the alkyl aluminoxane relative to the mass of the thermally treated layered double hydroxide.

A person of skill in the art will be able to select suitable reaction conditions (e.g. solvents, temperature, pressure, reaction times, agitation etc.) for step c). In particular embodiments, step c) is conducted in an organic solvent, such as toluene. Suitably, step c) is performed at a temperature of 50-100° C.

The process may further comprises a step of isolating the material resulting from step c), for example by filtration and vacuum drying.

According to a third aspect of the present invention, there is provided a catalyst support obtainable, obtained or directly obtained by the process of the first aspect.

### Catalyst Compositions

According to a second aspect of the present invention there is provided a process for preparing a catalyst composition, the process comprising the steps of:
a) providing a layered double hydroxide, the layered double hydroxide comprising Ni²⁺;
b) thermally treating the layered double hydroxide to a temperature of 100-600° C.;
c) contacting the thermally treated layered double hydroxide with an organoaluminium compound; and
d) supporting an olefin polymerisation catalyst on the thermally treated layered double hydroxide;
   wherein step d) is performed before, concurrent with, or after step c).

As alluded to hereinbefore, the catalyst compositions of the invention are useful in the preparation of polyolefins having tuneable MWD properties, in particular polyethylenes having a multimodal (e.g. bimodal) MWD.

The olefin polymerisation catalyst may be a metallocene, ansa-metallocene, half-metallocene or ansa-half-metallocene, examples of which will be readily familiar to one of skill in the art.

The olefin polymerisation catalyst may have a structure according to formula (II):

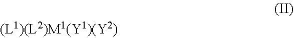

M¹ is zirconium, hafnium or titanium;
L¹ and L² are each independently a ligand comprising a cyclopentadienyl moiety, said cyclopentadienyl moiety being η⁵ bound to M¹, wherein L¹ and L² are optionally linked to one another; and
Y¹ and Y² are each independently a ligand selected from hydride, halo and (1-3C)alkyl.

In embodiments, L¹ and L² are each independently an optionally-substituted cyclopentadienyl group that is η⁵ bound to M¹, an optionally-substituted indenyl group that is η⁵ bound to M¹, or an optionally-substituted fluorenyl group that is η⁵ bound to M¹, wherein L¹ and L² are optionally linked to one another. More suitably, L¹ and L² are each independently an optionally-substituted cyclopentadienyl group that is η⁵ bound to M¹ or an optionally-substituted indenyl group that is η⁵ bound to M¹, wherein L¹ and L² are optionally linked to one another. In particular embodiments, L¹ and L² are each independently an optionally-substituted indenyl group that is η⁵ bound to M¹, wherein L¹ and L² are optionally linked to one another.

In embodiments, L¹ and L² are optionally linked to one another by an alkylene or a silylene linking group. L¹ and L² are optionally linked to one another by an ethylene group or a dimethylsilylene group.

In embodiments, M1 is zirconium.

In embodiments, Y1 and Y2 are each independently selected from hydride, chloro and methyl.

It will be understood that the optional substituents present in L¹ and L² may be selected from (1-6C)alkyl, (2-6C)alkenyl, (2-6C)alkynyl, (1-6C)alkoxy, aryl (e.g. phenyl), aryl(1-2C)alkyl (e.g. benzyl), aryloxy (e.g. phenoxy) and heteroaryl. Particularly suitable optional substituents are selected from (1-4C)alkyl, (1-4C)alkoxy and phenyl.

In particular embodiments, the olefin polymerisation catalyst is a bis-cyclopentadienyl zirconcene compound or a bis-indenyl zirconocene compound.

Particularly suitable olefin polymerisation catalysts include:

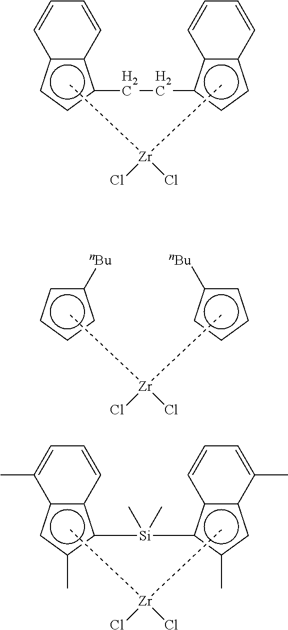

Most suitably, the olefin polymerisation catalyst is:

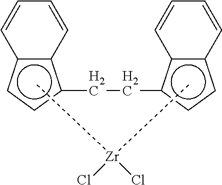

Steps a), b) and c) of the second aspect are respectively analogous to steps a), b) and c) of the first aspect. It will therefore be appreciated that steps a), b) and/or c) of the second aspect may respectively be as defined hereinbefore in relation to steps a), b) and/or c) of the first aspect.

Having regard to step d) of the process for preparing the catalyst composition, the person of ordinary skill in the art will be readily aware of techniques for supporting catalysts on supporting substrates, and will therefore be able to select appropriate reaction conditions (e.g. solvents, temperature, pressure, reaction times, agitation etc.). In particular embodiments, step d) is conducted in an organic solvent, such as toluene. Suitably, step d) is performed at a temperature of 30-100° C.

Step d) can be performed before, simultaneously with, or after step c). In other words, the olefin polymerisation catalyst can be supported (i.e. immobilized) onto the thermally-treated layered double hydroxide before, after, or at the same time as the thermally-treated layered double hydroxide is reacted with the organoaluminium compound. Typically, step d) is performed after step c).

The amount of olefin polymerisation catalyst used in step d) may be such that the mole ratio of olefin polymerisation catalyst to aluminium (from the organoaluminium compound) in the resulting catalyst composition is 1:50 to 1:300, more suitably 1:75 to 1:150.

The process may further comprises a step of isolating the catalyst composition resulting from performing steps a) to d), for example by filtration and vacuum drying.

According to a fourth aspect of the present invention, there is provided a catalyst composition obtainable, obtained or directly obtained by the process of the second aspect.

### Olefin Polymerisation

According to a fifth aspect of the present invention there is provided an olefin polymerisation process comprising the step of polymerising an olefin in the presence of the catalyst composition of the fourth aspect.

As alluded to hereinbefore, the catalyst compositions of the invention are useful in the preparation of polyolefins having tuneable MWD properties, in particular polyethylenes having a multimodal (e.g. bimodal) MWD.

In particular embodiments, the olefin is ethylene.

The olefin polymerisation process may be performed in the slurry phase. The skilled person will be readily able to select appropriate polymerisation conditions (e.g. solvents, pressure, reaction times, agitation etc.). In particular embodiments, the solvent is n-hexanes.

The olefin polymerisation process may be conducted in the presence of a co-catalyst. Suitably, the co-catalyst is an organoaluminium compound. Exemplary organoaluminium compounds include trimethyl aluminium, triethyl aluminium and triisobutyl aluminium, of which triisobutyl aluminium is favoured.

The olefin polymerisation process is suitably conducted at a temperature of 70-120° C. The temperature of the olefin polymerisation process can be used to tune the MWD of the resulting polyolefin. More suitably, the olefin polymerisation process is conducted at a temperature of 75-110° C. Even more suitably, the olefin polymerisation process is conducted at a temperature of 80-105° C. In particularly suitable embodiments, the olefin polymerisation process is conducted at a temperature of 85-95° C.

The following numbered statements 1 to 76 are not claims, but instead serve to define particular aspects and embodiments of the claimed invention:
1. A process for preparing a catalyst support, the process comprising the steps of:
   a) providing a layered double hydroxide, the layered double hydroxide comprising Ni²⁺;
   b) thermally treating the layered double hydroxide to a temperature of 100-600° C.; and
   c) contacting the thermally treated layered double hydroxide with an organoaluminium compound.
2. The process of statement 1, wherein Ni²⁺ accounts for at least 10 mol % of all monovalent and divalent metal cations present within the layered double hydroxide provided in step a).
3. The process of statement 1, wherein Ni²⁺ accounts for at least 30 mol % of all monovalent and divalent metal cations present within the layered double hydroxide provided in step a).
4. The process of statement 1, wherein Ni²⁺ accounts for at least 50 mol % of all monovalent and divalent metal cations present within the layered double hydroxide provided in step a).
5. The process of statement 1, wherein Ni²⁺ accounts for at least 70 mol % of all monovalent and divalent metal cations present within the layered double hydroxide provided in step a).
6. The process of statement 1, wherein Ni²⁺ accounts for at least 90 mol % of all monovalent and divalent metal cations present within the layered double hydroxide provided in step a).
7. The process of statement 1, wherein Ni²⁺ accounts for at least 95 mol % of all monovalent and divalent metal cations present within the layered double hydroxide provided in step a).
8. The process of any one of the preceding statements, wherein one or more of Mg²⁺, Zn²⁺, Fe²⁺, Ca²⁺, Cu²⁺ and Mn²⁺ form the optional balance of all monovalent and divalent metal cations within the layered double hydroxide provided in step a).
9. The process of any one of statements 1 to 7, wherein Mg²⁺ forms the optional balance of all monovalent and divalent metal cations within the layered double hydroxide provided in step a).
10. The process of any one of the preceding statements, wherein one or more of Al³⁺, Ga³⁺, Fe³⁺, Co³⁺, Mn³⁺ and V³⁺ accounts for all trivalent and tetravalent metal cations present within the layered double hydroxide provided in step a).
11. The process of statement 10, wherein Al³⁺ accounts for all trivalent and tetravalent metal cations present within the layered double hydroxide provided in step a).
12. The process of any one of statements 1 to 7, wherein Mg²⁺ forms the optional balance of all monovalent and divalent metal cations within the layered double hydroxide provided in step a), and wherein Al³⁺ accounts for all trivalent and tetravalent metal cations present within the layered double hydroxide provided in step a).
13. The process of any one of the preceding statements, wherein one or more of a halide, an inorganic oxyanion and a surfactant accounts for all anions present within the layered double hydroxide provided in step a).
14. The process of statement 13, wherein one or more inorganic oxyanion accounts for all anions present within the layered double hydroxide provided in step a).
15. The process of statement 14, wherein the inorganic oxyanion is carbonate.
16. The process of any one of statements 1 to 7, wherein Mg²⁺ forms the optional balance of all monovalent and divalent metal cations within the layered double hydroxide provided in step a), and wherein Al³⁺ accounts for all trivalent and tetravalent metal cations present within the layered double hydroxide provided in step a); and wherein carbonate accounts for all anions present within the layered double hydroxide provided in step a).
17. The process of statement 1, wherein the layered double hydroxide provided in step a) is of formula (I)

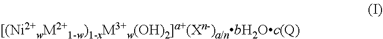

wherein
   M²⁺ is at least one divalent metal cation;
   M³⁺ is at least one trivalent metal cation;
   0.1≤w≤1;
   0<x<0.9;
   0≤b≤10;
   0≤c≤10;
   X is an anion
   n is the charge on anion X
   a=x; and
   Q is an organic solvent capable of hydrogen bonding to water.
18. The process of statement 17, wherein M²⁺ is one or more of Mg²⁺, Zn²⁺, Fe²⁺, Ca²⁺, Cu²⁺ and Mn²⁺.
19. The process of statement 17, wherein M²⁺ is Mg²⁺.
20. The process of statement 17, 18 or 19, wherein M³⁺ is one or more of Al³⁺, Ga³⁺, Fe³⁺, Co³⁺, Mn³⁺ and V³⁺.
21. The process of statement 20, wherein M³⁺is Al³⁺.
22. The process of statement 17, wherein M²⁺is Mg²⁺ and M³⁺ is Al³⁺.
23. The process of any one of statements 17 to 22, wherein X is one or more selected from a halide, an inorganic oxyanion and a surfactant.
24. The process of statement 23, wherein X is an inorganic oxyanion.
25. The process of statement 24, wherein the inorganic oxyanion is carbonate.
26. The process of statement 17, wherein M²⁺ is Mg²⁺, M³⁺ is Al³⁺ and X is carbonate.
27. The process of any one of statements 17 to 26, wherein 0.3≤w≤1.
28. The process of statement 27, wherein 0.5≤w≤1.
29. The process of statement 27, wherein 0.7≤w≥1.
30. The process of statement 27, wherein 0.9≤w≤1.
31. The process of statement 27, wherein 0.95≤w≤1.
32. The process of any one of statements 17 to 31, wherein 0.1≤x≤0.5.
33. The process of statement 32, wherein 0.2≤x≤0.4.
34. The process of any one of statements 17 to 33, wherein Q is one or more selected from acetone, ethanol, methanol and 1-hexanol.
35. The process of statement 34, wherein Q is ethanol.
36. The process of statement 17, M2+is Mg2+, M3+is Al3+, X is carbonate and Q is ethanol.
37. The process of any one of statements 17 to 35, wherein 0<c≤10.
38. The process of any one of the preceding statements, wherein step b) comprises thermally treating the layered double hydroxide provided in step a) to a temperature of 125-500° C.
39. The process of statement 38, wherein step b) comprises thermally treating the layered double hydroxide provided in step a) to a temperature of 150-450° C.
40. The process of statement 38, wherein step b) comprises thermally treating the layered double hydroxide provided in step a) to a temperature of 300-425° C.
41. The process of any one of the preceding statements, wherein step b) comprises thermally treating the layered double hydroxide at a rate of 3-20 K/minute.
42. The process of statement 41, wherein step b) comprises thermally treating the layered double hydroxide at a rate of 5-15 K/minute.
43. The process of any one of the preceding statements, wherein the layered double hydroxide is thermally treated at 100-600° C. (or at 125-500° C., 150-450° C. or 300-425° C.) for 0.5-5 hours.
44. The process of statement 43, wherein the layered double hydroxide is thermally treated at 100-600° C. (or at 125-500° C., 150-450° C. or 300-425° C.) for 2-4 hours.
45. The process of any one of the preceding statements, wherein step b) is performed under vacuum.
46. The process of any one of the preceding statements, wherein step c) comprises contacting the thermally treated layered double hydroxide with 10-70 wt % of the organoaluminium compound relative to the mass of the thermally treated layered double hydroxide.
47. The process of statement 46, wherein step c) comprises contacting the thermally treated layered double hydroxide with 25-55 wt % of the organoaluminium compound relative to the mass of the thermally treated layered double hydroxide.
48. The process of statement 46, wherein step c) comprises contacting the thermally treated layered double hydroxide with 35-45 wt % of the organoaluminium compound relative to the mass of the thermally treated layered double hydroxide.
49. The process of any one of the preceding statements, wherein step c) is conducted in an organic solvent (e.g. toluene).
50. The process of any one of the preceding statements, wherein the organoaluminium compound is an alkyl aluminoxane.
51. The process of statement 50, wherein the alkyl aluminoxane is a methyl aluminoxane.
52. A process for preparing a catalyst composition, the process comprising the steps of:
   a) providing a layered double hydroxide, the layered double hydroxide comprising Ni²⁺;
   b) thermally treating the layered double hydroxide to a temperature of 100-600° C.;
   c) contacting the thermally treated layered double hydroxide with an organoaluminium compound; and
   d) supporting an olefin polymerisation catalyst on the thermally treated layered double hydroxide;
wherein step d) is performed before, concurrent with, or after step c).
53. The process of claim 52, wherein step a), b) and/or c) is respectively as defined for step a), b) and/or c) in any one of claims 1 to 51.
54. The process of statement 52 or 53, wherein the olefin polymerisation catalyst is a metallocene, ansa-metallocene, half-metallocene or ansa-half-metallocene.
55. The process of statement 52, 53 or 54, wherein the olefin polymerisation catalyst has a structure according to formula (II):

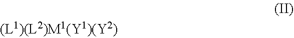

M¹ is zirconium, hafnium or titanium;
L¹ and L² are each independently a ligand comprising a cyclopentadienyl moiety, said cyclopentadienyl moiety being η⁵ bound to M¹, wherein L¹ and L² are optionally linked to one another; and
Y¹ and Y² are each independently a ligand selected from hydride, halo and (1-3C)alkyl.
56. The process of statement 55, wherein L¹ and L² are each independently an optionally-substituted cyclopentadienyl, optionally-substituted indenyl, or optionally-substituted fluorenyl group that is n5 bound to M¹, wherein L¹ and L² are optionally linked to one another.
57. The process of statement 55, wherein L¹ and L² are each independently an optionally-substituted indenyl group that is η⁵ bound to M¹, wherein L¹ and L² are optionally linked to one another.
58. The process of statement 55, 56 or 57, wherein L¹ and L² are optionally linked to one another by an alkylene or a silylene linking group.
59. The process of statement 58, wherein the alkylene linking group is ethylene and the silylene linking group is dimethylsilylene.
60. The process of any one of statements 55 to 59, wherein M¹ is zirconium.
61. The process of any one of statements 55 to 60, wherein Y¹ and Y² are each independently selected from hydride, chloro and methyl.
62. The process of statements 52, 53 or 54, wherein the olefin polymerisation catalyst is a bis-cyclopentadienyl zirconcene compound or a bis-indenyl zirconocene compound.
63. The process of statement 52, 53 or 54, wherein the olefin polymerisation catalyst is any one of the following:

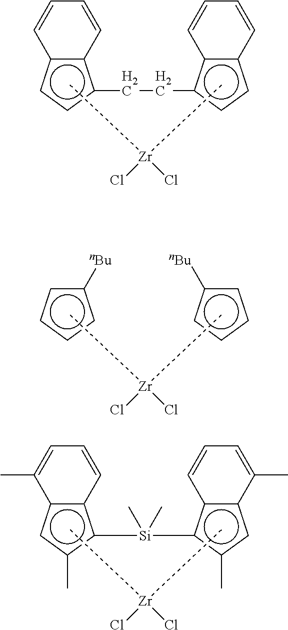

64. The process of statement 52, 53 or 54, wherein the olefin polymerisation catalyst is:

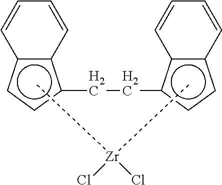

65. The process of any one of statements 52 to 64, wherein step d) is performed after step c).
66. The process of any one of statements 52 to 65, wherein the amount of olefin polymerisation catalyst used in step d) is such that the mole ratio of olefin polymerisation catalyst to aluminium (from the organoaluminium compound) in the resulting catalyst composition is 1:50 to 1:300.
67 A catalyst support obtainable by the process of any one of statements 1 to 51.
68. A catalyst composition obtainable by the process of any one of statements 52 to 66.
69. An olefin polymerisation process comprising the step of polymerising an olefin in the presence of the catalyst composition of statement 68.
70. The process of statement 69, wherein the olefin is ethylene.
71. The process of statement 69 or 70, wherein the olefin polymerisation process is performed in the slurry phase.
72. The process of statement 69, 70 or 71, wherein the olefin polymerisation process is performed in the presence of a co-catalyst.
73. The process of any one of statements 69 to 72, wherein the olefin polymerisation process is conducted at a temperature of 70-120° C.
74. The process of any one of statements 69 to 72, wherein the olefin polymerisation process is conducted at a temperature of 75-110° C.
75. The process of any one of statements 69 to 72 wherein the olefin polymerisation process is conducted at a temperature of 80-105° C.
76. The process of any one of statements 69 to 72, wherein the olefin polymerisation process is conducted at a temperature of 85-95° C.

### EXAMPLES

One or more examples of the invention will now be described, for the purpose of illustration only, with reference to the accompanying figures, in which:

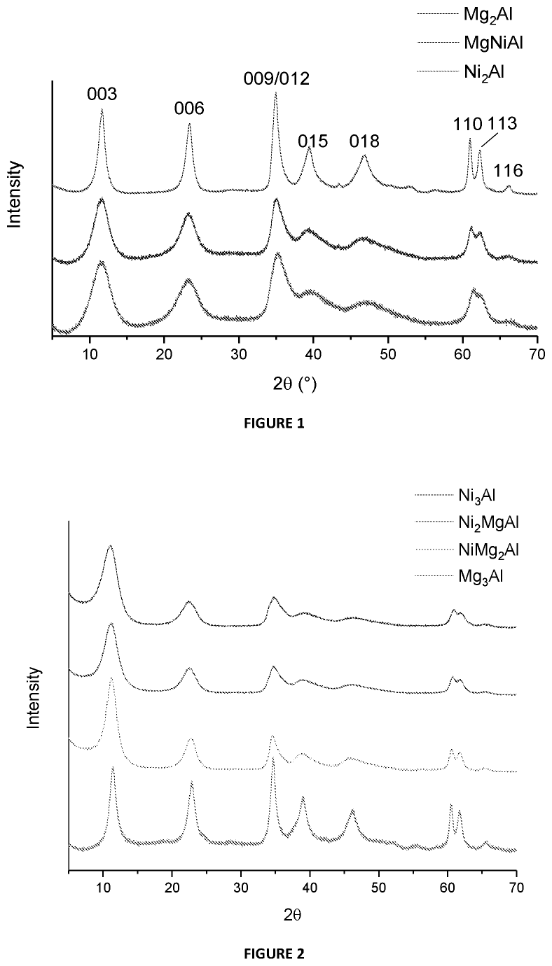

FIG. 1 shows XRD powder patterns of NiₓMg₂₋ₓAl LDH.

FIG. 2 shows XRD powder patterns of Niₓ(Mg₃₋ₓ)Al LDH.

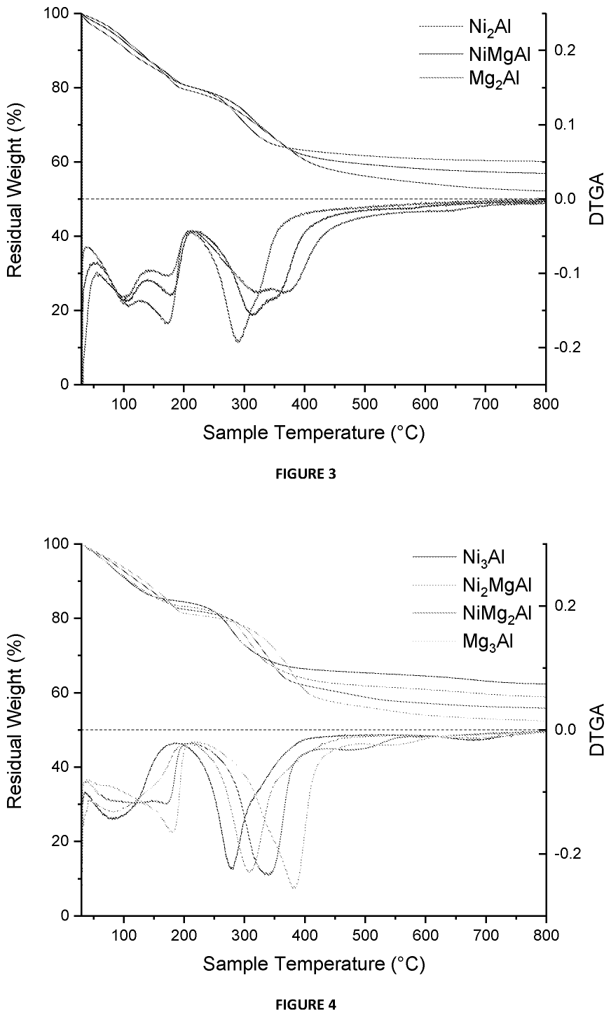

FIG. 3 shows TGA curves of NiₓMg₂₋ₓAl-LDH.

FIG. 4 shows TGA curves for NiₓMg₃₋ₓAl-LDH.

FIG. 5 shows unit cell parameter, a, corresponding to the metal-metal distance showing a near linear decrease with nickel content.

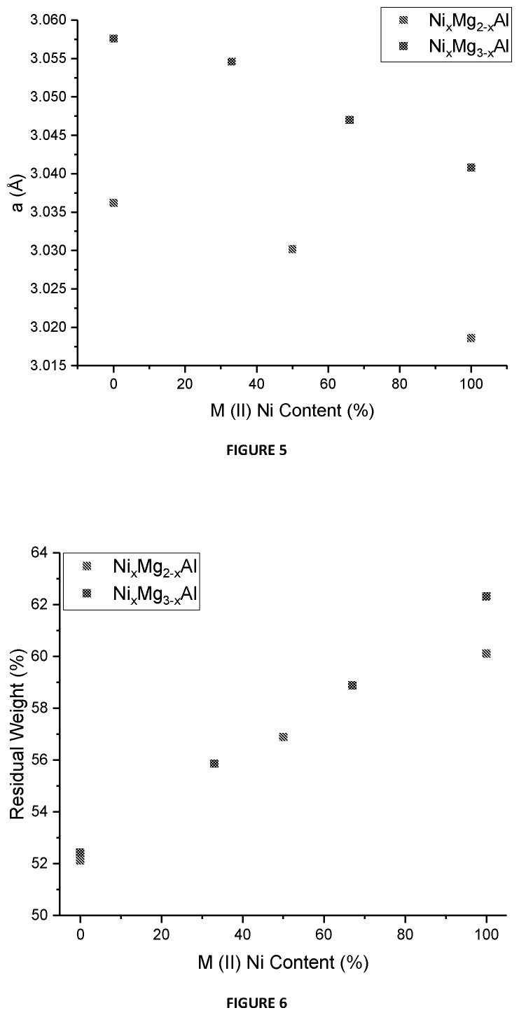

FIG. 6 shows a plot of the residual weight at 800° C. as determined by TGA analysis, showing an approximately linear increase in weight with nickel content.

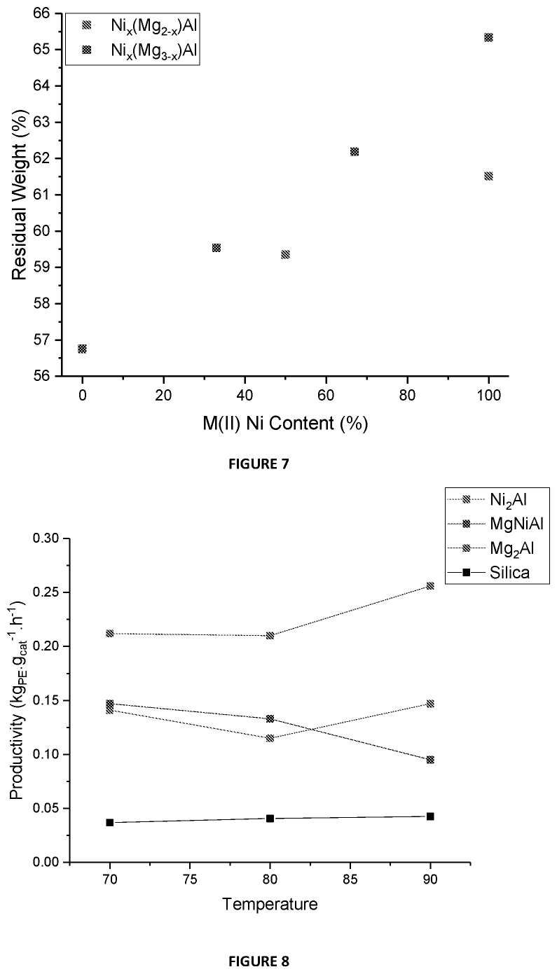

FIG. 7 shows a plot of the residual weight after calcination under nitrogen, (400° C., 3 h with a 10 K·min-⁻¹ ramp from 30-400° C.) showing an approximately linear increase in weight with nickel content.

FIG. 8 shows the productivity of catalysts based on calcined LDH supports (NiₓMg₂₋ₓAl).

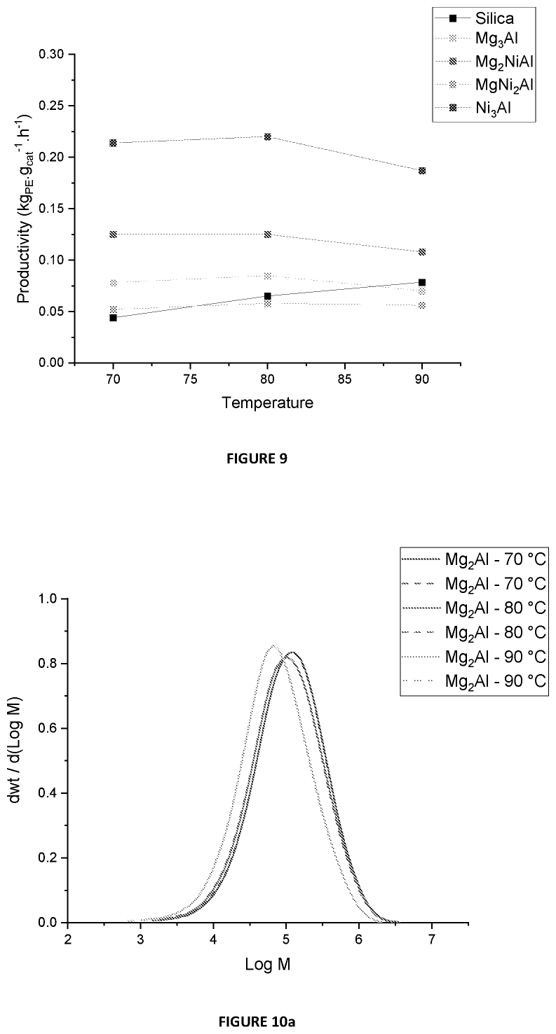

FIG. 9 shows the productivity of catalysts based on calcined LDH supports (NiₓMg₃₋ₓAl).

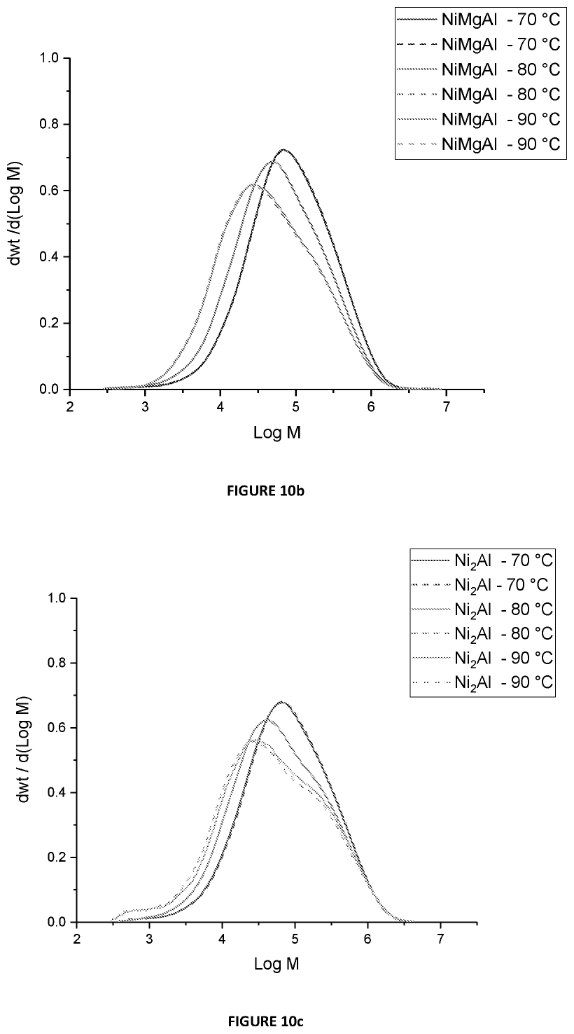

FIG. 10 shows: a) MWD of polyethylene produced by (EBI)ZrCl₂ immobilised on supports derived from Mg₂Al LDH at various temperatures; b) MWD of polyethylene produced by (EBI)ZrCl₂ immobilised on supports derived from NiMgAl LDH at various temperatures; c) MWD of polyethylene produced by (EBI)ZrCl₂ immobilised on supports derived from Ni₂Al LDH at various temperatures.

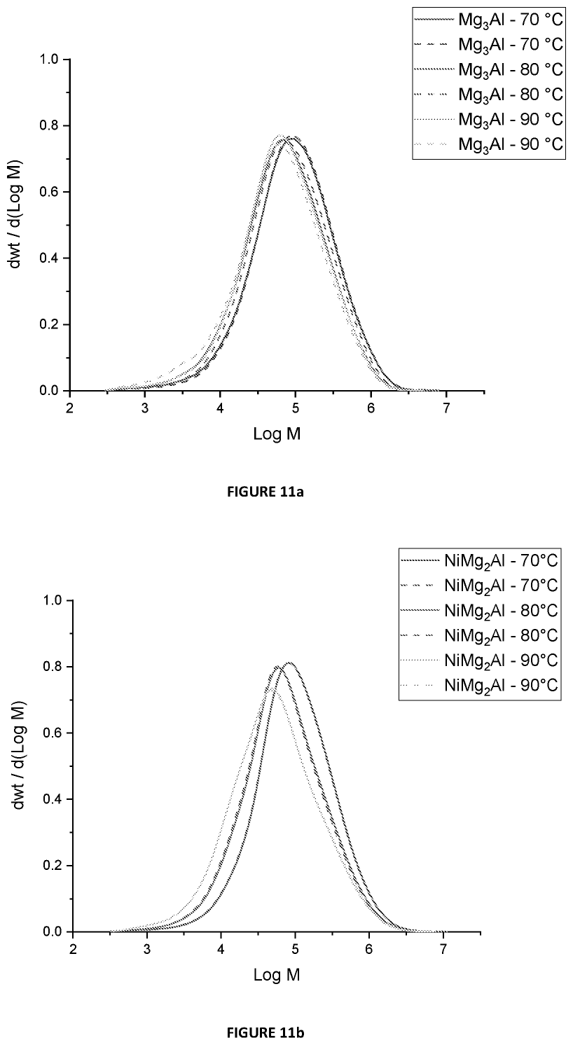

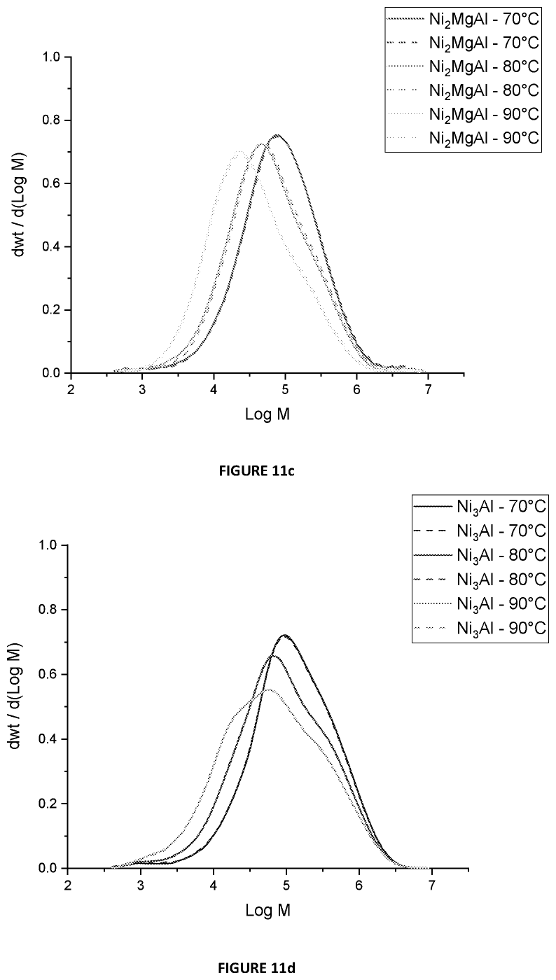

FIG. 11 shows: a) MWD of polyethylene produced by (EBI)ZrCl₂ immobilised on supports derived from Mg3Al LDH at various temperatures; b) MWD of polyethylene produced by (EBI)ZrCl₂ immobilised on supports derived from NiMg₂Al LDH at various temperatures; c) MWD of polyethylene produced by (EBI)ZrCl₂ immobilised on supports derived from Ni₂MgAl LDH at various temperatures; d) MWD of polyethylene produced by (EBI)ZrCl2 immobilised on supports derived from Ni3Al LDH at various temperatures.

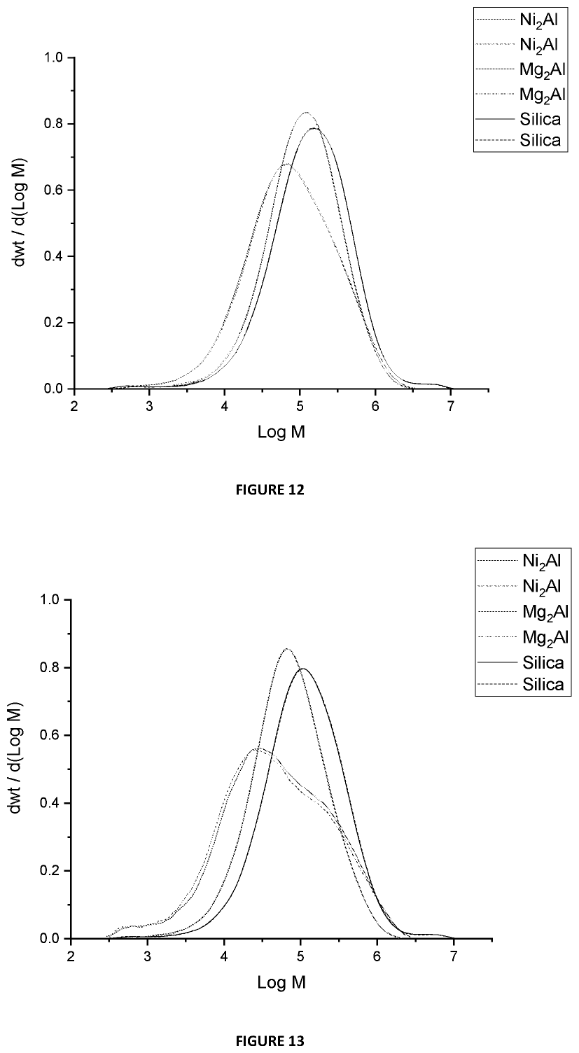

FIG. 12 shows MWD of polyethylene produced using two selected catalysts based on NiₓMg₂₋ₓAl-LDH and the silica reference at 70° C.

FIG. 13 shows MWD of polyethylene produced using two selected catalysts based on NiₓMg₂₋ₓAl-LDH and the silica reference at 90° C.

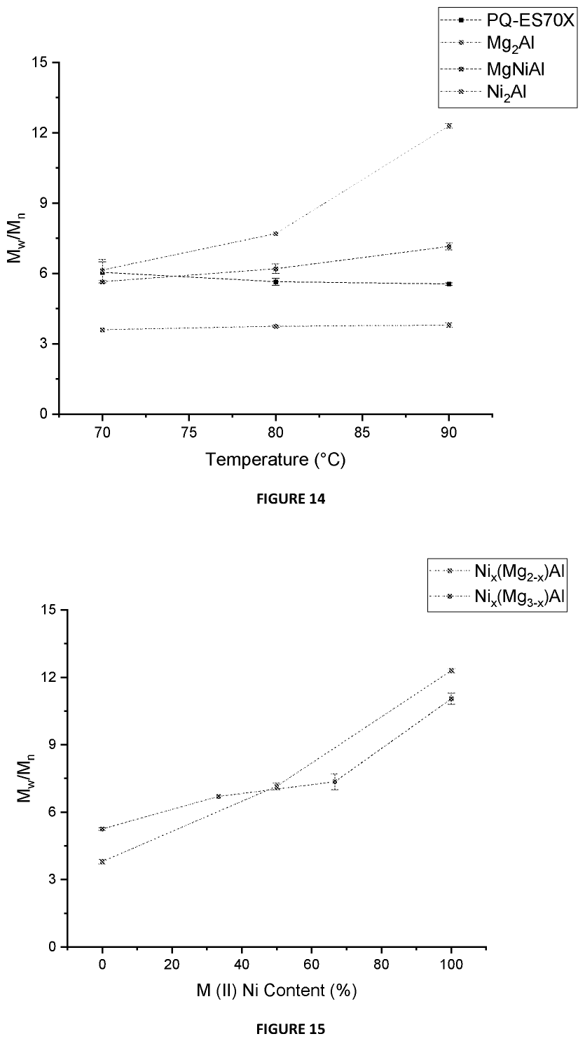

FIG. 14 shows the change in dispersity (M_{w}/Mₙ) with temperature for catalysts based on Niₓ(Mg₂₋ₓ)Al supports. Reference catalyst based on a silica support is also included.

FIG. 15 shows the change in dispersity (M_{w}/Mₙ) at 90° C. showing an increase with increasing nickel content for catalysts based on NiₓMg₂₋ₓAl and NiₓMg₃₋ₓAl LDH supports.

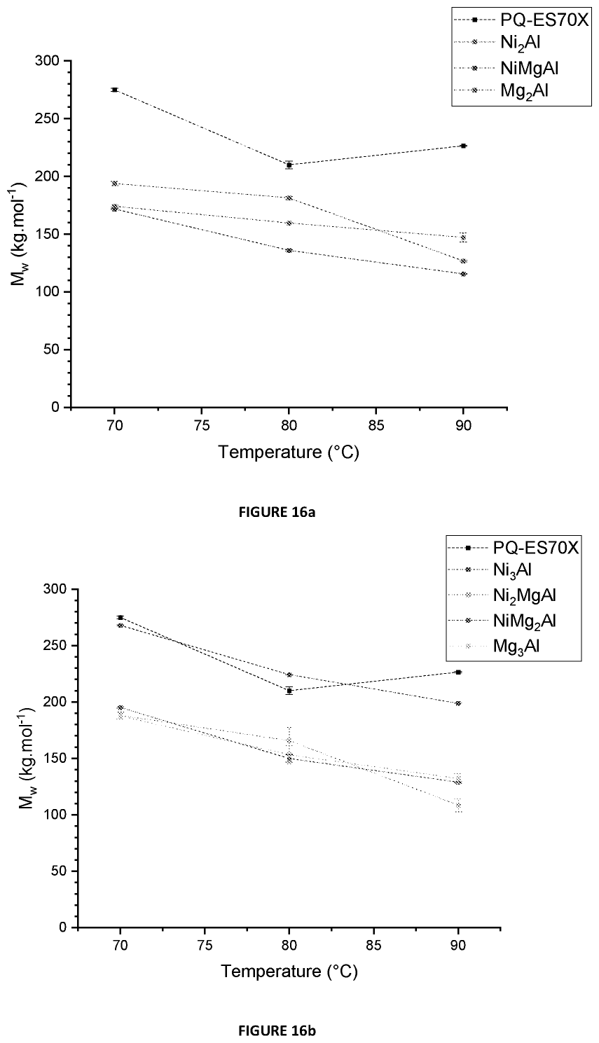

FIG. 16 shows: a) the change in molecular weight (M_{w}) with temperature for polyethylene produced by (EBI)ZrCl₂ immobilised on supports derived from NiₓMg₂₋ₓAl LDH and a silica reference; b) the change in molecular weight (M_{w}) with temperature for polyethylene produced by (EBI)ZrCl₂ immobilised on supports derived from NiₓMg₃₋ₓAl LDH and a silica reference.

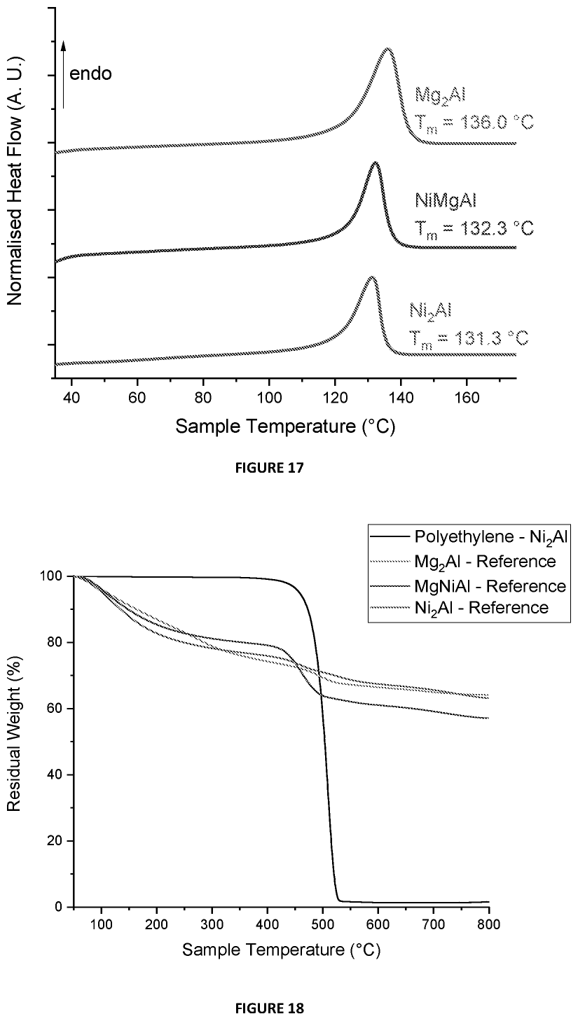

FIG. 17 shows DSC of polyethylene produced at 90° C. using selected catalysts based on supports derived from Mg₂Al, NiMgAl and Ni₂Al.

FIG. 18 shows TGA curves of inorganic material collected after reference polymerisations and the bimodal polyethylene produced by (EBI)ZrCl₂ immobilized on a support derived from Ni₂Al LDH at 90° C.

### General Considerations

All air-sensitive chemistry was carried out under an inert atmosphere using Schlenk line or glove-box techniques. Toluene and n-hexanes were collected from an MBraun SPS, degassed on a Schlenk line and stored over a potassium mirror for at least 12 hours before use.

d-MAO used was dried Axion CA1330 provided by Chemtura, dried on a Schlenk line and then stored in a glove-box before use. (EBI)ZrCl₂ (STREM Chemicals) and TiBA (Aldrich) were stored in a glovebox prior to use.

Al(NO₃)₃·9H₂O (99.999% trace metals), Mg(NO₃)₂·6H₂O (99.999% trace metals) and Ni(NO₃)₂·6H₂O (99.999% trace metals), NaOH (>98%, pellets), ethanol (>99.8%) and pentanes (>99%) were purchased from Aldrich and used as received.

Powder X-ray diffraction (PXRD) analysis was carried out using a PANAnalytical X′Pert Pro Diffractometer in scanning mode using Cu Kα radiation (α1=1.540598 Å, α2=1.544426 Å) in reflection mode at 40 kV and 40 mA. The samples were packed on stainless steel holders which can result in peaks at 43.36, 44.29, and 50.51° but which did not interfere with the analysis. Signals between 2θ=2−70° were recorded with step size 0.0167°.

Thermogravimetric analyses (TGA) were performed under a nitrogen atmosphere using a PerkinElmer TGA 8000. The weight change was recorded from 30-800° C. (5 K·min⁻¹). For calcination under nitrogen, the weight change was recorded from 30-400° C. (10 K·min⁻¹) and over the 3 hour hold period.

Polymerisations were run in duplicate, if results were not consistent (defined here as within 10% of the mean) a third polymerisation was carried out and the average value reported is that of the two consistent runs. If the third polymerisation was consistent with both original runs, or if after three runs no consistent results were obtained the average value reported is that of all three runs.

HT-GPC were carried out by AS-Norner, each sample was run in duplicate on a high temperature gel permeation chromatograph with a IR5 infrared detector (GPC-IR5) Samples were dissolved in trichlorobenzene (TCB) with 300 ppm of 3,5-di-tert-butyl-4-hydroxytoluene (BHT) at 160° C. for 90 minutes and filtered with a 10 μm filter. Samples were run using TCB (300 ppm BHT) at a flow rate of 0.5 mL·min⁻¹ as a mobile phase with 1 mg/mL BHT added as a flow rate marker. The GPC column and detector were set at 145 and 160° C. respectively.

### Synthesis

### Preparation of Niₓ(Mg₃₋ₓ)Al LDH ([(NiₓMg₁₋ₓ)_{0.75}Al_{0.25}(OH)₂](CO₃)_{0.125}·bH₂O·c(Ethanol))

25 mmol Al(NO₃)₃·9H₂O and the appropriate amounts of Mg(NO₃)₂·6H₂O and Ni(NO₃)₂·6H₂O (75 mmol in total) were dissolved in 100 mL deionised water. This was then added at 100 mL·h⁻¹ to a sodium carbonate solution (12.5 mmol in 100 mL deionised water), throughout the addition the pH was monitored and the solution was maintained at pH 10 using 5 M NaOH. After the addition was complete the white suspension was stirred overnight (18 hours). The white solid was then filtered off and washed with deionised water until the filtrate was neutral. The white solid was then washed with 1 litre of ethanol, before resuspending the solid in 600 mL ethanol and stirring for four hours. The white solid was then collected by filtration, washed with 400 mL ethanol and dried overnight in a vacuum oven (<30 mBar, R.T.).

### Preparation of Niₓ(Mg₂₋ₓ)Al LDH ([(NiₓMg₁₋ₓ)_{0.66}Al_{0.33}(OH)₂](CO₃))_{0.175}·bH₂O·c(Ethanol))

25 mmol Al(NO₃)₃·9H₂O and the appropriate amounts of Mg(NO₃)₂·6H₂O and Ni(NO₃)₂·6H₂O (50 mmol in total) were dissolved in 75 mL deionised water. This was then added at 100 mL·h⁻¹ to a sodium carbonate solution (12.5 mmol in 75 mL deionised water), throughout the addition the pH was monitored and the solution was maintained at pH 10 using 5 M NaOH. After the addition was complete the white suspension was stirred overnight (18 hours). The white solid was then filtered off and washed with deionised water until the filtrate was neutral. The white solid was then washed with 1 litre of ethanol, before resuspending the solid in 600 mL ethanol and stirring for four hours. The white solid was then collected by filtration, washed with 400 mL ethanol and dried overnight in a vacuum oven (<30 mBar, R.T.).

### Vacuum Calcination of Niₓ(Mg_{y-x})Al LDH (y=3 or 2)

500 mg of Niₓ(Mg_{y-x})Al LDH was placed in a ceramic crucible, which was then placed in a quartz tube. This tube was placed in a tube furnace, connected to a Schlenk line and carefully placed under vacuum. Once a suitably low vacuum was reached (<2×10⁻¹ mBar) the sample was heated to 400° C. at a heating rate of 10 K·min⁻¹, once the furnace reached 400° C. this temperature was maintained for 3 hours. The tube was under dynamic vacuum throughout the calcination and after calcination the tube was sealed and brought into a glovebox where the calcined supports [Niₓ(Mg_{y-x})Al (400° C., 3 h, 10 K·min⁻¹)] were stored.

### Preparation of Catalyst Support [Niₓ(Mg_{y-x})Al (400° C., 3 h, 10 K·min⁻¹)/40 wt.% d-MAO]

250 mg of calcined support Niₓ(Mg_{y-x})Al (400° C., 3 h, 10 K·min⁻¹) and 100 mg d-MAO were weighed out and mixed as solids. Toluene (50 mL) was then added and the sample was heated to 80° C. To ensure an even distribution of d-MAO on the support the suspension was swirled continuously for 15 minutes and then swirled every 5 minutes for 105 minutes. After 2 hours, the suspension was allowed to cool and the toluene was filtered off. The wet solid was dried under vacuum and the catalyst support [Niₓ(Mg_{y-x})Al (400° C., 3 h, 10 K·min-⁻¹)/40 wt.% d-MAO] stored in a glovebox.

### Preparation of Catalyst Composition [Niₓ(Mg_{y-x})Al (400° C., 3 h, 10 K·min⁻¹)/40 wt. % d-MAO/(EBI)ZrCl₂]

200 mg of catalyst support [Niₓ(Mg_{y-x})Al (400° C., 3 h, 10 K·min⁻¹)/40 wt. % d-MAO] and 4.2 mg (EBI)ZrCl₂ (10 μmol Zr, approx. 100:1 Al_{[MAO]}:Zr) were weighed out and mixed as solids. Toluene (15 mL) was then added and the sample heated to 60° C. To ensure an even distribution of (EBI)ZrCl₂ on the catalyst support, the suspension was swirled as toluene was added and swirled continuously for 15 minutes and then swirled every 5 minutes for 45 minutes. After 1 hour, the suspension was allowed to cool and the toluene was decanted. The wet solid was dried under vacuum and the catalyst [Niₓ(Mg_{y-x})Al (400° C., 3 h, 10 K·min⁻¹)/40 wt. % d-MAO/(EBI)ZrCl₂] stored in a glovebox.

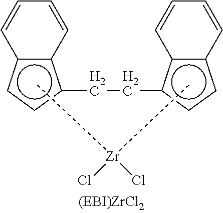

### Polymerisation

### General Procedure

In a glovebox, approx. 150 mg of TiBA was dissolved in 10 mL n-hexanes and added to a 150 mL ampoule and 10 mg of catalyst was then added. A further 40 mL of n-hexanes was then added, and the ampoule sealed and brought out of the glovebox. The ampoule was cycled on to a Schlenk line, heated to the desired temperature using an oil bath and stirred using a magnetic stirrer bar at 1000 rpm. The ampoule was carefully evacuated, and then pressurised to 2 Bar with ethylene. Polymerisation was carried out for 30 minutes, after which the ampoule was vented carefully, and the polymer isolated by filtration and washed with pentanes (50 mL) before air drying.

### Results and Discussion

The purity of the LDHs can be seen to be in the good agreement between the theoretical and actual nickel contents (Table 1), the XRD powder patterns (NiₓMg₂₋ₓAl shown in FIG. 1, NiₓMg₃₋ₓAl shown in FIG. 2) and the TGA curves (NiₓMg₂₋ₓAl shown in FIG. 3, NiₓMg₃₋ₓAl shown in FIG. 4).

TABLE 1
LDH Supports Synthesised in this Study and their Composition

| Support | Theoretical | Actual | Theoretical | Actual | Residual | |
|---|---|---|---|---|---|---|
| Sample | Ni:Mg | Ni:Mg | M (II) Ni | M(II) Ni | Weight at | Metal-Metal |
| Name | Ratio^{a} | Ratio^{b} | Content (%)^{c} | Content (%)^{d} | 800° C. (%)^{e} | Distance (Å)^{f} |
| Mg₂Al | 0:2 | 0:0.82 | 0 | 0 | 52.1 | 3.0362 |
| NiMgAl | 1:1 | 0.98:0.99 | 50 | 49.6 | 56.9 | 3.0302 |
| Ni₂Al | 2:0 | 1.95:0 | 100 | 100 | 60.1 | 3.0186 |
| Mg₃Al | 0:3 | 0:2.87 | 0 | 0 | 52.4 | 3.0576 |
| NiMg₂Al | 1:2 | 0.94:1.92 | 33.3 | 32.9 | 55.7 | 3.0546 |
| Ni₂MgAl | 2:1 | 1.92:0.96 | 66.7 | 66.81 | 58.9 | 3.0470 |
| Ni₃Al | 3:0 | 2.89:0 | 100 | 100 | 62.3 | 3.0408 |

^{a}Based on molar ratios of metal nitrates used in the synthesis, relative to Al.
^{b}Determined by ICP-MS, relative to Al.
^{c}Based on ratios of metal nitrates used in the synthesis.
^{d}As determined by ICP-MS.
^{e}As determined by TGA, 30-800° C., 5 K · min⁻¹.
^{f}Determined from the 110 peak in the XRD powder pattern.

These XRD powder patterns show the expected peaks associated with an LDH. There is a shift in the 110 peak to higher values of 2θ as the M(II) nickel content is increased. This is observed for both the NiₓMg₃₋ₓAl and the NiₓMg₂₋ₓAl series and is consistent with a decrease in the metal-metal distance a decreasing as the larger Mg²⁺ ion is replaced with the smaller Ni²⁺ ion. Values for the metal-metal distance can be determined using Bragg's law (given in Table 1) and plotting these against the theoretical M(II) nickel content reveals an approximately linear trend for both series (FIG. 5).

The TGA curves show the expected weight losses associated with calcination of an LDH. Below 200° C. there is loss of interlayer solvent molecules (ethanol and water) seen as distinct maxima in the DTGA at approximately 90 and 170° C. respectively. As the nickel content changes the ratio between these two peaks changes suggesting a change in the composition of the interlayer solvents. Above 200° C., dehydroxylation of OH bonds in the LDH occurs, this is associated with the partial loss of the carbonate anion and formation of amorphous mixed metal oxides.^{7, 8} The dehydroxylation temperature has been previously shown to be dependent on the nature of the M(OH)M₂ bonds (amongst other factors) and as nickel content increases the dehydroxylation temperature decreases. For both series as the nickel content increases, the residual weight at 800° C. increases as the magnesium ions are replaced by heavier nickel ions.

Importantly, the residual weight at 800° C. correlates with the theoretical M(II) nickel content (FIG. 6), suggesting there are no amorphous impurities in the samples which were not observed in the powder XRD patterns. In combination these measurements suggest that these nickel supports are synthetically pure and suitable for use in studying the influence of the nickel content on polymerisation.

To generate an appropriate mixed metal oxide support, the LDH were calcined at 400° C. under vacuum for 3 hours, the supports were then treated with d-MAO (40 wt. %) to generate an appropriate support for a metallocene and (EBI)ZrCl₂ was immobilised onto the support. Polymerisations were carried out using hexanes as the diluent and TiBA as a scavenger. A catalyst using silica (PQ-ES70X) as the support is included for comparison purposes (Table 2).

TABLE 2
Polymerisation using LDH Supports with Varying Nickel Contents^{a}

| | Temperature | Productivity^{b} | Activity^{b} | M_{w}^{c} | |
|---|---|---|---|---|---|
| Support | (° C.) | (kg_{PE} · g_{cat}⁻¹ · h¹) | (kg_{PE} · mol_{Zr}⁻¹ · h⁻¹) | (kg · mol¹) | M_{w}/Mₙ^{c} |
| Mg₂Al | 70 | 0.212 | 4330 | 194 | 3.6 |
| | 80 | 0.210 | 4290 | 181 | 3.8 |
| | 90 | 0.256 | 5220 | 127 | 3.8 |
| NiMgAl | 70 | 0.147 | 3000 | 172 | 5.6 |
| | 80 | 0.133 | 2710 | 135 | 6.4 |
| | 90 | 0.095 | 1940 | 115 | 7.0 |
| Ni₂Al | 70 | 0.141 | 2880 | 173 | 5.9 |
| | 80 | 0.115 | 2350 | 160 | 7.7 |
| | 90 | 0.147 | 3000 | 151 | 12.2 |
| Mg₃Al | 70 | 0.078 | 1590 | 190 | 5.7 |
| | 80 | 0.085 | 1730 | 161 | 5.3 |
| | 90 | 0.070 | 1430 | 140 | 5.3 |
| NiMg₂Al | 70 | 0.125 | 2550 | 196 | 5.2 |
| | 80 | 0.125 | 2550 | 153 | 5.7 |
| | 90 | 0.108 | 2200 | 129 | 6.7 |
| Ni₂MgAl | 70 | 0.052 | 1060 | 185 | 6.3 |
| | 80 | 0.058 | 1180 | 153 | 7.4 |
| | 90 | 0.056 | 1140 | 115 | 7.7 |
| Ni₃Al | 70 | 0.214 | 4370 | 267 | 7.2 |
| | 80 | 0.220 | 4490 | 224 | 9.0 |
| | 90 | 0.187 | 3820 | 199 | 11.3 |
| Silica (PQ- | 70 | 0.044 | 900 | 274 | 5.6 |
| ES70X)^{d} | 80 | 0.065 | 1330 | 207 | 5.5 |
| | 90 | 0.079 | 1600 | 227 | 5.5 |

^{a}Polymerisation conditions: 10 mg supported catalyst (0.49 μmol Zr), 50 mL hexanes, 150 mg TiBA, 2 bar ethylene, 30 minutes.
^{b}Average based on two consistent polymerisations.
^{c}Determined by HT-GPC, carried out by AS-Norner, all measurements carried out in duplicate, values from single measurement.
^{d}Silica support calcined at 400° C. for 6 h.

Productivity of the LDH supports is either comparable to the silica reference or significantly higher (see FIGS. 8 and 9) However, no clear trends in terms of nickel content have been observed.

However, the dramatic change comes in the MWD of the polymer produced. While a broad MWD (M_{w}/Mₙ>5) is obtained for nearly all the supports used here, for the LDH series containing nickel a much broader MWD can be obtained, especially at higher temperatures.

While an approximately monomodal MWD is obtained for all catalysts at 70° C., at 90° C. catalysts based on supports with a high nickel content (e.g. Ni₂Al) have clearly become bimodal, while those based on nickel free LDH supports (e.g. Mg₂Al) and the silica reference retain their monomodal distribution (see, for example, FIGS. 12-14).

Clearly, when a metallocene is immobilized on an LDH containing nickel, a lower molecular weight fraction is produced. This low molecular weight fraction must still be generated by the metallocene and is likely the result of a distinct ion pair forming under polymerization conditions, which has distinct reactivity with (for example) the scavenger TiBA. The enhanced rate of chain termination, relative to propagation associated with the low molecular weight fraction may also explain the generally lower productivity of these catalysts as reinsertion following termination is generally considered to have a higher barrier than for insertion into a polymer chain.

The polymers produced are clearly linear and display sharp melting and crystallization curves with peak melting temperatures typical of HDPE produced by metallocenes, even when a clearly bimodal polyethylene is produced (see FIG. 17). Reference polymerisations were carried out (see Table 3) for the calcined Niₓ(Mg₂₋ₓ)Al series, treated with d-MAO, but omitting the metallocene. Polymerisations were carried out under the same conditions, but only at 90° C., as this is the temperature when the bimodality is most significant and therefore if the second fraction comes from the support it will be the temperature when the support produces most polymer.

TABLE 3
Polymerisation using LDH catalyst supports.^{a}

| | | | | Average |
|---|---|---|---|---|
| | | | Productivity | Productivity |
| Support | Support (mg) | Yield (g) | (kg · g_{cat}⁻¹ · h⁻¹) | (kg · g_{cat}⁻¹ · h⁻¹) |
| Mg₂Al | 9.5 | 0.010 | 0.002 | 0.002 |
| | 10.4 | 0.006 | 0.001 | |
| NiMgAl | 9.5 | Trace | n/a | 0.003 |
| | 9.9 | 0.014 | 0.003 | |
| Ni₂Al | 9.6 | 0.005 | 0.001 | 0.003 |
| | 10.5 | 0.027 | 0.005 | |

^{a}Polymerisation conditions: Approx. 10 mg catalyst support [Niₓ(Mg_{y-x})Al (400° C., 3 h, 10 K · min⁻¹)/40 wt. % d-MAO], 150 mg TiBA (scavenger), 50 mL hexanes (diluent), 2 bar ethylene, 90° C., 30 minutes.

In all cases minimal solids are recovered, which were assumed to be residues of the inorganic support and potentially traces of the partially decomposed scavenger. TGA of the samples carried out under N₂ from 50-800° C. showed TGA curves that are consistent with mixed metal oxides that have partially reconstructed to LDH under atmospheric exposure, with considerable mass remaining even at 800° C. By contrast the bimodal polyethylene produced by (EBI) ZrCl₂ immobilized on a support derived from Ni₂Al LDH at 90° C. shows a typical TGA profile of polyethylene, with almost all weight being lost in a single step at 510° C. (see FIG. 18). The reference experiments therefore clearly demonstrate the role of the metallocene in producing the low molecular weight fraction

The observed bimodality is temperature sensitive (see, for example, FIGS. 12-14), but it can also be tuned by the nickel content of the support (FIG. 15). As the nickel content is increased, the bimodality increases, as can be observed by the change in dispersity (M_{w}/Mₙ) this triples from approximately 4 (for Mg₂Al) to over 12 (for a Ni₂Al LDH support at 90° C.). The ability to exert control over the modality of the MWD of the resulting polymer (e.g., the extent to which it displays a bimodal distribution) is industrially advantageous.

In conclusion, incorporating nickel into an LDH based support allows for generation of bimodal polyethylene from a single catalyst on a single support. This bimodality can be tuned by the degree of nickel in the support and is also influenced by polymerisation temperature.

While specific embodiments of the invention have been described herein for the purpose of reference and illustration, various modifications will be apparent to a person skilled in the art without departing from the scope of the invention as defined by the appended claims.

### REFERENCES

1. Tervoort, T. A.; Visjager, J.; Smith, P., On Abrasive Wear of Polyethylene. Macromolecules 2002, 35 (22), 8467-8471.
2. Stürzel, M.: Mihan, S.: Mülhaupt, R., From Multisite Polymerization Catalysis to Sustainable Materials and All-Polyolefin Composites. Chem. Rev. 2016, 116 (3), 1398-433.
3. Lafleur, S.; Berthoud, R.; Ensinck, R.; Cordier, A.; De Cremer, G.; Philippaerts, A.; Bastiaansen, K.; Margossian, T.; Severn, J. R., Tailored bimodal ultra-high molecular weight polyethylene particles. J. Polym. Sci. A. 2018, 56 (15), 1645-1656.
4. Mecking, S., Reactor blending with early/late transition metal catalyst combinations in ethylene polymerization. Macromol. Rapid. Comm. 1999, 20 (3), 139-143.
5. Liu, H.; Bastiaansen, C. W. M.; Goossens, J. G. P.; Schenning, A. P. H. J.; Severn, J. R., Bimodal Ultrahigh Molecular Weight Polyethylenes Produced from Supported Catalysts: The Challenge of Using a Combined Catalyst System. Macromol. Chem. Phys. 2017, 218 (5).
6. Zhong, F.; Thomann, R.; Mülhaupt, R., Tailoring Mono-, Bi-, and Trimodal Molar Mass Distributions and All-Hydrocarbon Composites by Ethylene Polymerization on Bis(imino)pyridine Chromium(III) Supported on Ultrathin Gibbsite Single Crystal Nanoplatelets. Macromolecules 2019, 52 (7), 2701-2711.
7. Bellotto, M.; Rebours, B.; Clause, O.; Lynch, J.; Bazin, D.; Elkaïm, E., Hydrotalcite Decomposition Mechanism: A Clue to the Structure and Reactivity of Spinel-like Mixed Oxides. J. Phys. Chem. 1996, 100 (20), 8535-8542.
8. Yang, W.; Kim, Y.; Liu, P. K. T.; Sahimi, M.; Tsotsis, T. T., A study by in situ techniques of the thermal evolution of the structure of a Mg—Al—CO3 layered double hydroxide. Chem. Eng. Sci. 2002, 57 (15), 2945-2953.

1. A process for preparing a catalyst support, the process comprising the steps of:
a) providing a layered double hydroxide, the layered double hydroxide comprising Ni²⁺;
b) thermally treating the layered double hydroxide to a temperature of 100-600° C.; and
c) contacting the thermally treated layered double hydroxide with an organoaluminium compound.

2. The process of claim 1, wherein Ni²⁺ accounts for at least 30 mol % of all monovalent and divalent metal cations present within the layered double hydroxide provided in step a).

3. The process of claim 1 or 2, wherein one or more of Mg²⁺, Zn²⁺, Fe²⁺, Ca²⁺, Cu²⁺ and Mn²⁺ form the optional balance of all monovalent and divalent metal cations within the layered double hydroxide provided in step a), and one or more of Al³⁺, Ga³⁺, Fe³⁺, Co³⁺, Mn³⁺ and V³⁺ accounts for all trivalent and tetravalent metal cations present within the layered double hydroxide provided in step a).

4. The process of claim 1, 2 or 3, wherein Mg²⁺ forms the optional balance of all monovalent and divalent metal cations within the layered double hydroxide provided in step a).

5. The process of any one of the preceding claims, wherein Al³⁺ accounts for all trivalent and tetravalent metal cations present within the layered double hydroxide provided in step a).

6. The process of any one of the preceding claims, wherein one or more inorganic oxyanion accounts for all anions present within the layered double hydroxide provided in step a).

7. The process of claim 1, wherein the layered double hydroxide provided in step a) is of formula (I) 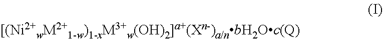
wherein
M²⁺ is at least one divalent metal cation;
M³⁺ is at least one trivalent metal cation;
0.1≤w≤1;
0<x<0.9;
0≤b≤10;
0≤c≤10;
X is an anion
n is the charge on anion X
a=x; and
Q is an organic solvent capable of hydrogen bonding to water.

8. The process of claim 7, wherein M²⁺ is one or more of Mg²⁺, Zn²⁺, Fe²⁺, Ca²⁺, Cu²⁺ and Mn²⁺ and M³⁺ is one or more of Al³⁺, Ga³⁺, Fe³⁺, Co³⁺, Mn³⁺ and V³⁺.

9. The process of claim 7 or 8, wherein M²⁺ is Mg²⁺.

10. The process of claim 7, 8 or 9, wherein M³⁺ is Al³⁺ and X is an inorganic oxyanion.

11. The process of any one of claims 7 to 10, wherein the inorganic oxyanion is carbonate.

12. The process of any one of claims 7 to 11, wherein 0.5≤w≤1.

13. The process of any one of claims 7 to 12, wherein Q is one or more selected from acetone, ethanol, methanol and 1-hexanol.

14. The process of any one of claims 7 to 13, wherein 0<c≤10.

15. The process of any one of the preceding claims, wherein step b) comprises thermally treating the layered double hydroxide provided in step a) to a temperature of 150-450° C.

16. The process of any one of the preceding claims, wherein step c) comprises contacting the thermally treated layered double hydroxide with 10-70 wt % of the organoaluminium compound relative to the mass of the thermally treated layered double hydroxide, wherein the organoaluminium compound is an alkyl aluminoxane.

17. A process for preparing a catalyst composition, the process comprising the steps of:
a) providing a layered double hydroxide, the layered double hydroxide comprising Ni²⁺;
b) thermally treating the layered double hydroxide to a temperature of 100-600° C.;
c) contacting the thermally treated layered double hydroxide with an organoaluminium compound; and
d) supporting an olefin polymerisation catalyst on the thermally treated layered double hydroxide;
wherein step d) is performed before, concurrent with, or after step c).

18. The process of claim 17, wherein step a), b) and/or c) is respectively as defined for step a), b) and/or c) in any one of claims 1 to 16.

19. The process of claim 17 or 18, wherein the olefin polymerisation catalyst is a metallocene, ansa-metallocene, half-metallocene or ansa-half-metallocene.

20. The process of claim 17, 18 or 19, wherein the olefin polymerisation catalyst is a bis-cyclopentadienyl zirconcene compound or a bis-indenyl zirconocene compound.

21. The process of claim any one of claims 17 to 20, wherein the olefin polymerisation catalyst is any one of the following:

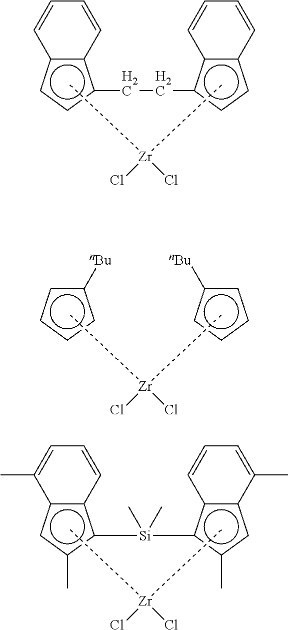

22. A catalyst support obtainable by the process of any one of claims 1 to 16.

23. A catalyst composition obtainable by the process of any one of claims 17 to 21.

24. An olefin polymerisation process comprising the step of polymerising an olefin in the presence of the catalyst composition of claim 23.

25. The process of claim 24, wherein the olefin is ethylene and wherein the olefin polymerisation process is performed in the slurry phase.
